(19) United States
(12) Patent Application Publication
(10) Pub. No.: US 2012/0312649 A1
(43) Pub. Date: Dec. 13, 2012

(54) Shock Absorbers

(76) Inventor: Graeme Kershaw Robertson, Yandina (AU)

(21) Appl. No.: 13/391,817

(22) PCT Filed: Aug. 25, 2010
(86) PCT No.: PCT/AU2010/001094

§ 371 Date: Mar. 24, 2012

(30) Foreign Application Priority Data
Aug. 25, 2009 (AU) 2009904059

(51) Int. Cl. F16F 9/348; F16F 9/516

(52) U.S. Cl. 188/313; 188/322.15

(57) ABSTRACT

A motion damping device, such as a shock absorber, has a damper valve having a valve body (11) including a first face (20, 23) on a first side of the valve body and a second face (23, 20) on the opposing second side of the valve body. The damper valve also has at least first valving (25, 26, 27, 33, 34, 35) to provide a restriction to fluid flow across the damper valve in a first direction from the second side of the of the damper valve to the first side. The first valving has a first valving disc seat (24, 32) on the second face of the valve body. The first valving disc seat has an outer edge. At least one first valving port (21, 31) extends through the valve body from the first side to the second side and exits the valve body inside the outer edge of the first valving seat. The at least one first valving disc is seated on the first valving disc seat. A first valving disc clamping face (27, 33) is located substantially inside the at least one first valving port, the height of the first valving disc clamping face being offset from the maximum height of the first valving disc seat in a direction towards the valve body such that clamping of the at least one first valving disc to the first valving disc clamping face deflects the at least one first valving disc to a static preloaded position. The first valving disc seat is concave, conical, dished, or the like, such that in cross-section the angle of the first valving seat is greater than or equal to the angle of the at least one first valving disc in the static preloaded position.

### TECHNICAL FIELD

The present invention is in the field of motion damping and more particularly, valving for motion damping devices.

### BACKGROUND

Damping of automobile body motions and oscillations of the wheels is usually performed using fluid-filled telescopic “shock absorbers”. The extension (generally referred to as rebound) damping force in such applications is typically three times the damping force in compression motions. Two different constructions of shock absorber are generally used, the mono tube which has a gas reservoir separated by a piston from the fluid in the compression chamber of the shock absorber, or the twin tube in which the gas reservoir is located in a sleeve around the piston cylinder and communicated with the compression chamber by a damper valve. In both cases, the piston of the shock absorber usually provides a fluid restriction and therefore damping force in both the compression and rebound directions. Conventionally this fluid restriction is provided by valving which uses holes having a similar flow path in compression and rebound and flexible shims which are, at best, of similar size and operation in both compression and rebound. Also the piston area over which the rebound chamber acts is only an annular area around the rod whereas the compression chamber acts over the full diameter of the piston, which naturally generates a higher force in compression. In order to achieve the desired ratio between compression and rebound damping force without generating excessive shim stresses and reducing the reliability of the shock absorber, the range of damping force available is restricted. Although many different designs aim to overcome this, most require a much greater axial cylinder length than that of a simple piston, reducing the available stroke from a given length of shock absorber or increasing the length.

The applicant's U.S. Pat. No. 7,513,490 (details of which are incorporated herein by reference) provides a piston rod arrangement having the compression flow through ports towards the outer of the piston face. The rebound flow is separate, not utilising the annular area of the piston around the rod (which is used for the compression flow ports) but instead flowing through ports into the rod and through the central region of the piston face which provides a smaller and more restrictive flow path inherently providing a higher rebound damping force.

It is known to provide a narrow raised strip on the piston face to provide a seat for the shims to rest against. In some designs, the seat is raised above the height at which the shims are held, deflecting the shims and providing a pre-load force which must be overcome before the shims lift from the seat and allow flow through the gap generated by that lift off the seat. The width of the seat is very low as the shims are intended to sit on an edge which gives a seal between shim and piston for all pre-load deflections of the shims. However the narrow seat is prone to damage with a small chip or dent permitting unintended flow when the shim is seated on the narrow seat which changes the damping force giving a variation from the intended damping characteristics of the shock absorber.

It is therefore an object of the present invention to provide a valve having improved seating for increased repeatability and reliability within a motion damping device such as a shock absorber.

### SUMMARY OF THE INVENTION

With this in mind, there is provided a motion damping device including a damper valve having a valve body including a first face on a first side of the valve body and a second face on the opposing second side of the valve body, the damper valve further including at least first valving to provide a restriction to fluid flow across the damper valve in a first direction from the second side of the of the damper valve to the first side, the first valving including:

a first valving disc seat on the second face of the valve body, the first valving disc seat having an outer edge,

at least one first valving port extending through the valve body from the first side to the second side, the at least one first valving port exiting the valve body inside the outer edge of the first valving seat,

at least one first valving disc seated on the first valving disc seat,

a first valving disc clamping face located substantially inside the at least one first valving port, the height of the first valving disc clamping face being offset from the maximum height of the first valving disc seat in a direction towards the valve body such that clamping of the at least one first valving disc to the first valving disc clamping face deflects the at least one first valving disc to a static preloaded position; wherein

the first valving disc seat is concave such that in cross-section, the angle of the first valving seat is greater than or equal to the angle of the at least one first valving disc in the static preloaded position. If the angle of the seating surface of the concave first valving disc seat is equal to the angle of the at least one first valving disc in the static preloaded position, the preload force would be reacted over the largest possible area and any foreign objects that could cause damage to the seating surface would be unlikely to provide additional pathways for fluid to leak between the valve disc and the seating surface. This minimises variations in the damping characteristic of the valve due to such damage, making the valve more reliable and repeatable over its lifetime than conventional narrow seat designs. However tolerance variations and the tendency for the valve disc to stick to the seating surface make the ideal angle of the valve seat slightly greater than the angle of the valve disc in the statically preloaded position, so that the valve disc has the greatest pressure at its outer rim rather than further inwards which could otherwise permit leakage from the valve port(s) past the outer rim of the valve disc. The requirements can vary dependent on the design of valving (i.e. whether a slotted disc is used between the rest of the valve discs and the seat to provide a low speed fluid flow path).

The damper valve may further include second valving to provide a restriction to fluid flow across the damper valve in a second direction from the first side of the of the damper valve to the second side, the second valving including:

a second valving disc seat on the first face of the valve body, the second valving disc seat having an outer edge,

at least one second valving port extending from outside the outer edge of the first valving seat on the second side of the valve body through to the first side, the at least one second valving port exiting the valve body at a location radially separated outwardly from the location of the at least one first valving port on the first face and inside the outer edge of the second valving disc seat,

at least one second valving disc seated on the second valving disc seat,

a second valving disc clamping face located substantially inside the at least one second valving port, the height of the second valving disc clamping face being offset from the maximum height of the second valving disc seat in a direction towards the valve body such that clamping of the at least one second valving disc to the second valving disc clamping face deflects the at least one second valving disc to a static preloaded position, wherein

the second valving disc seat is concave such that in cross-section, the angle of the second valving seat is greater than or equal to the angle of the at least one second valving disc in the static preloaded position.

This provides the same benefits of increased reliability and repeatability over time for damping in the second direction.

The motion damping device may include a cylinder, a piston dividing the cylinder into a compression chamber and a rebound chamber, and a rod extending from the piston through at least the rebound chamber. In this case the piston may include the damper valve, the first face of the damper valve may be a compression face, the first valving may be compression valving, the second face may be a rebound face and the second valving may be rebound valving.

At least one rebound port may be in fluid communication with a passage in the rod, the passage in the rod being in fluid communication with the rebound chamber through at least one peripheral rod port such that rebound flow out of the rebound chamber flows through the at least one peripheral rod port, through the passage in the rod and through the at least one rebound port.

An alternative form of the present invention provides a shock absorber assembly including a cylinder, a piston dividing the cylinder into a compression chamber and a rebound chamber, and a rod extending from the piston through at least the rebound chamber, the piston having a compression chamber piston face and an annular rebound chamber piston face, a rebound disc seat being provided on the compression chamber piston face and a compression disc seat being provided on the rebound chamber piston face,
compression ports arranged outside the rebound disc seat of the compression chamber piston face passing through the piston to inside an outer edge of the compression disc seat on the annular rebound chamber piston face,
at least one rebound port arranged inside the outer edge of the rebound disc seat of the compression chamber piston face, the at least one rebound port being in fluid communication with a passage in the rod, the passage in the rod being in fluid communication with the rebound chamber through at least one peripheral rod port such that rebound flow out of the rebound chamber flows through the at least one peripheral rod port, through the passage in the rod and through the at least one rebound port,
the shock absorber further including at least one compression disc clamped to the compression disc seat of the annular rebound chamber piston face and at least one rebound disc clamped to the rebound disc seat of the compression chamber piston face, such that compression flow between the compression and rebound chambers flows at least substantially through the compression ports and rebound flow between the compression and rebound chambers flows at least substantially through the at least one rebound port;
wherein the compression disc seat is raised a height above the rebound chamber piston face, the at least one compression disc being clamped down against a compression disc clamping face which is lower than the height of the compression disc seat giving a deflection of the at least one compression disc, the compression disc seat being angled to provide a sealing surface substantially aligned with the at least one compression disc, and
the rebound disc seat is raised a height above the compression chamber piston face, the at least one rebound disc being clamped down against a rebound disc clamping face which is lower than the height of the rebound disc seat giving a deflection of the at least one rebound disc, the rebound disc seat being angled to provide a sealing surface substantially aligned with the at least one rebound disc.

An alternative form of the present invention provides a shock absorber assembly including a cylinder, a piston dividing the cylinder into a compression chamber and a rebound chamber, and a rod extending from the piston through at least the rebound chamber, the piston having a compression chamber piston face and an annular rebound chamber piston face, a rebound disc seat being provided on the compression chamber piston face and a compression disc seat being provided on the rebound chamber piston face,
compression ports arranged outside the rebound disc seat of the compression chamber piston face passing through the piston to inside an outer edge of the compression disc seat on the annular rebound chamber piston face,
at least one rebound port arranged inside the outer edge of the rebound disc seat of the compression chamber piston face, the at least one rebound port being in fluid communication with a passage in the rod, the passage in the rod being in fluid communication with the rebound chamber through at least one peripheral rod port such that rebound flow out of the rebound chamber flows through the at least one peripheral rod port, through the passage in the rod and through the at least one rebound port,
the shock absorber further including at least one compression disc connected to the compression disc seat of the annular rebound chamber piston face and at least one rebound disc connected to the rebound disc seat of the compression chamber piston face, such that compression flow between the compression and rebound chambers flows at least substantially through the compression ports and rebound flow between the compression and rebound chambers flows at least substantially through the at least one rebound port;
wherein the compression disc seat projects beyond the rebound chamber piston face, the at least one compression disc being connected against a compression disc face beyond which the compression disc seat projects giving a deflection of the at least one compression disc, the compression disc seat being angled to provide a sealing surface substantially aligned with the at least one compression disc, and
the rebound disc seat projects beyond the compression chamber piston face, the at least one rebound disc being connected against a rebound disc face beyond which the rebound disc seat projects giving a deflection of the at least one rebound disc, the rebound disc seat being angled to provide a sealing surface substantially aligned with the at least one rebound disc.

The present application is particularly efficacious for application in low axial length of package in a shock absorber.

The compression disc clamping face may be at substantially the same angle as the compression disc seat. The compression disc clamping face can be a continuation of a surface defined by the compression disc seat, separated from the compression disc seat by a channel being the rebound chamber piston face.

The rebound disc clamping face may be at substantially the same angle as the rebound disc seat. The rebound disc clamping face can be a continuation of a surface defined by the rebound disc seat, separated from the rebound disc seat by a channel being the compression chamber piston face.

The compression and rebound chambers may be filled with hydraulic liquid. The compression chamber may be in communication with a gas filled reservoir. The pre-charge pressure of the gas reservoir may be varied to adjust the damping properties of the shock absorber assembly.

### BRIEF DESCRIPTION OF THE DRAWINGS

FIG. 1 is a section through a part of a shock absorber in accordance with at least one embodiment of the present invention.

FIG. 2 is a similar section through part of a shock absorber illustrating at least one alternate embodiment of the present invention.

FIG. 3 is a section through a damping valve in accordance with at least one embodiment of the present invention.

### DETAILED DESCRIPTION OF THE INVENTION

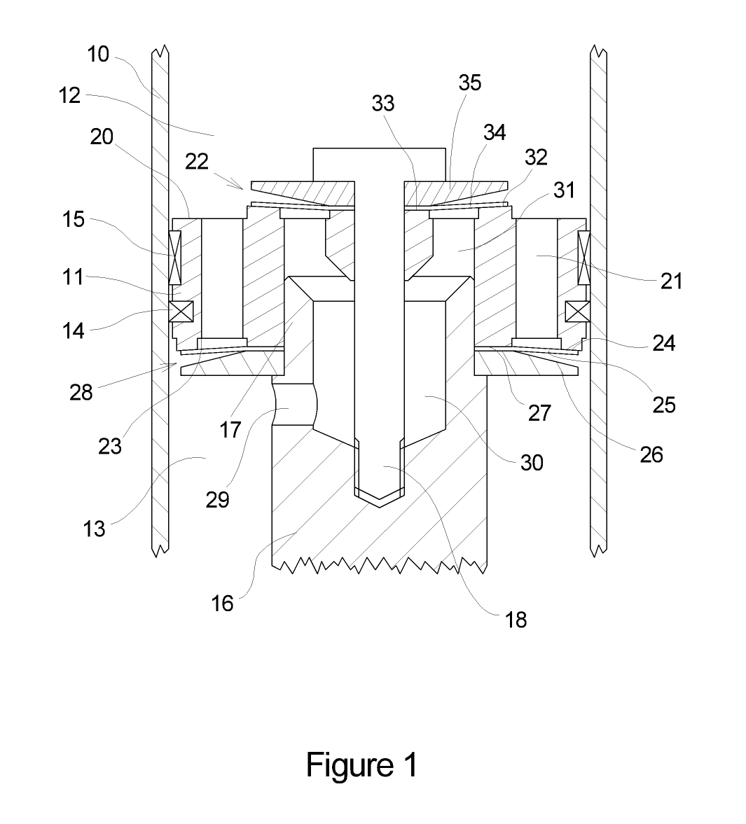

In FIG. 1 there is shown a portion of a shock absorber cylinder 10. A piston 11 divides the cylinder into a compression chamber 12 and a rebound chamber 13, the piston seal 14 being provided to prevent significant fluid flow around the outside of the piston. The piston 11 can slide axially inside the cylinder 10, piston bearing 15 providing a low friction for such axial motions (especially when there is a side load or bending moment applied to the shock absorber) and controlling the radial clearance between piston and cylinder.

Rod 16 passes through the rebound chamber and includes a spigot 17 which fits inside the piston 11. A screw 18 clamps the piston onto the end of the rod.

On the top face of the piston, facing the compression chamber (ie the compression chamber piston face 20), a ring of compression ports 21 pass through the piston. The compression ports are located outside the rebound valving 22. The compression ports 21 exit the lower face of the piston facing the rebound chamber (i.e. the rebound chamber piston face 23), inside the compression disc seat 24. The compression disc 25 is clamped between a compression washer 26 and the compression disc clamping face 27 on the piston. The compression disc is seated against the compression disc seat 24 (which is raised off the rebound chamber piston face 23) and is deflected into a slightly concave, conical or dished shape (exaggerated in the Figure for clarity) by being clamped towards its centre onto the compression disc clamping face 27 which can be at the same height (or even recessed into the rebound chamber piston face) but in this case protrudes proud of the rebound chamber piston face, but by less than the compression disc seat 24. The width of the compression disc seat sealing surface is typically at least 1.5 mm.

The compression washer 26 is shaped to permit a repeatable deflection of the compression disc 25, but to prevent excessive deflection which could cause permanent deflection of the compression disc and loss of damping force characteristic. This improves repeatability and reliability of the compression valving 28.

The rod has a radial hole forming a peripheral rod port 29 joining a passage 30 in the rod to the rebound chamber 13. The passage 30 exits the end of the rod inside the piston 11 where it is communicated with the rebound port(s) 31 which can be one or more holes in the compression chamber piston face of the piston. The rebound ports 31 are located between the rebound disc seat 32 and the rebound disc clamping face 33. The rebound disc 34 is clamped between a rebound washer 35 and the rebound disc clamping face 33.

As the shock absorber is compressed, the piston 11 slides upwards in the cylinder 10, reducing the volume of the compression chamber, so fluid pressure increases in the compression chamber. The rebound disc is seated against the rebound disc seat performing like a check valve preventing significant fluid flow through the rebound ports. The compression flow passes through the compression ports and acts over the annular surface of the compression disc lifting it off the compression disc seat, generating a gap between the disc and the seat which is proportional to a function of the pressure on either side of the compression disc. The compression disc can be a stack of discs of similar or varying diameters and thicknesses to provide control of the damping characteristics, being shown as a single disc for simplicity.

Conversely, as the shock absorber is extended (a motion in an automobile commonly referred to as rebound) the piston 11 slides downwards in the cylinder 10, reducing the volume of the rebound chamber, so fluid pressure increases in the rebound chamber. The compression disc is seated against the compression disc seat performing like a check valve preventing significant fluid flow through the compression ports. The rebound flow passes through the peripheral rod port 29 and the passage in the rod 30 to the rebound port or ports 31 and acts over the annular surface of the rebound disc lifting it off the rebound disc seat, generating a gap between the disc and the seat which is proportional to a function of the pressure on either side of the rebound disc. The rebound disc can be a stack of discs of similar or varying diameters and thicknesses to provide control of the damping characteristics, being shown as a single disc for simplicity.

The deflection caused by the clamping of the disc generates an initial pre-load force on the disc which can be used as a tuning parameter for the shock absorber. Different amounts of deflection can be gained, for example in the compression valving 28 by using smaller diameter shims between the clamping face 27 and the disc 25. However if the amount of deflection is changed by too much, the angle of the seat can become too different to the angle formed by the disc 25. To that end, different pistons can be made having the angle of each seat (compression and rebound) matched to the respective disc deflection caused by the height difference between each particular clamping face and seat.

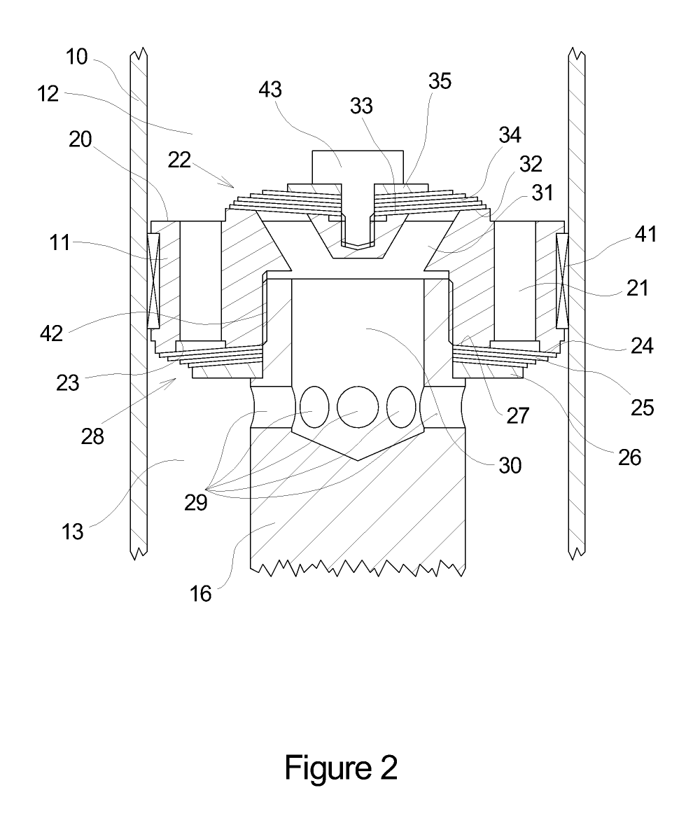

The piston valve arrangement shown in FIG. 2 is similar to that in FIG. 1 with like components having like reference numerals. The piston bearing and seal have been replaced by a band 41 of material (such as a bearing material like PTFE) which can be used to provide the bearing and sealing functions of both the piston bearing and piston seal of FIG. 1.

In FIG. 2 the compression disc seat 24 and compression disc clamping face 27 are in a common concave, conical or dished plane, but still separated by the rebound chamber piston face through which the compression ports 21 exit the piston. The piston 11 is threaded onto the rod 16, with both piston and rod including threaded portions at 42, this thread being tightened to pre-load the compression discs 25.

The screw 43 clamps the rebound valving 22 onto the piston which has the rebound disc seat 32 and rebound disc clamping face 33 in the same concave, conical or dished plane forming a single concave surface through which the rebound ports 31 exit the piston.

Both the compression and rebound discs are shown now as multiple shims or other resiliently flexible plates of varying diameter (and they can have varying thickness, but are shown thick for clarity). In this design of shim stack, the washers 26 and 35 are not always required to limit the deflection so are shown as smaller diameter.

Multiple peripheral rod ports 29 are shown between the rebound chamber 13 and the passage 30 in the rod.

The use of a concave or angled valve disc seat can be applied to other damping valves. For example in twin tube shock absorbers an additional damper valve is commonly used between the compression chamber and the reservoir and in some damping arrangements, the fluid is passed through a separate valve. For example, in a controlled shock absorber, a double acting ram can be used having a solid piston, i.e. one without valving holes so no flow is metered over the piston. Instead all fluid passes between the compression and rebound chambers via external passages and/or conduits. The controlled damping can include switching between different damper valves or by controlling a valve in parallel or in series with a passive damper valve of preset characteristic. Damper valves external to the ram can also be used where there are interconnections between the rams.

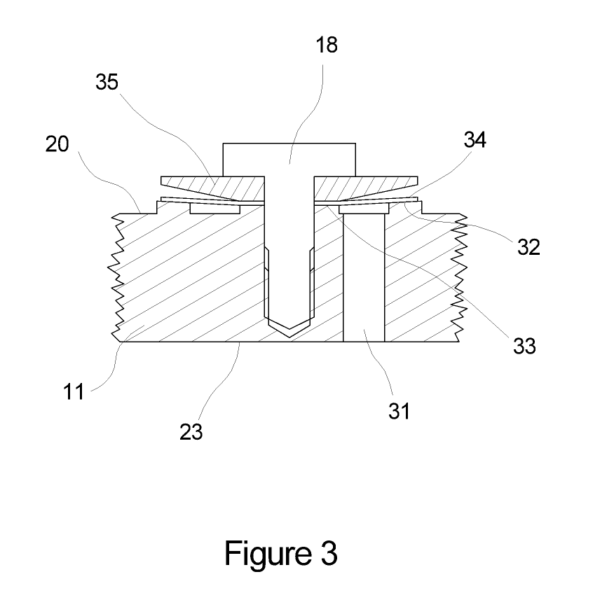

FIG. 3 shows the passive damping elements of a valve which can be used in many locations. The rebound damping element from FIG. 1 is adapted for use as part of a damper valve for use in locations other than the piston of a shock absorber. The screw 18 is threaded into the body 11 of the valve to load the valve discs 34 against the valve disc seat 32 and the disc clamping face 33. The valve disc seat is angled to a similar angle to that of the discs when statically loaded. The valve washer 35 protects the valve discs from deflecting beyond their yield point, or any amount of deflection that may be determined to cause the valve discs to permanently deform which would otherwise change the characteristic of the valve. The valve body 11 is clamped or otherwise held in location such that fluid passing from the plain face 23 of the valve body to the valve disc face 20 of the valve body flows through the at least one valve port 31, deflecting the discs 34 and passing through the gap formed by the deflection of the discs off the valve seat.

An additional spring can be used to apply a preload in the valving to provide a “blow-off” to hold the restriction high for lower flows and reduce the restriction for high flows. This is widely known and commonly used in shock absorber valves and can be particularly useful in helping to compensate for the exponential increase in restriction vs flow rate through the high speed orifice elements of a damper valve.

In either a monotube shock absorber application or a twin tube shock absorber application, the compression and rebound chambers are most likely to be filled with hydraulic liquid. The compression chamber is then conventionally in communication with a reservoir of pressurised gas. The damping properties can be adjusted by varying the pre-charge pressure of the gas volume in the reservoir. This adjusts both the static extension (or “push-out”) force of the shock absorber assembly and the damping force at which cavitation of the hydraulic fluid will occur.

The pressure in the gas volume of the reservoir (and therefore the operating pressure of the shock absorber assembly) can optionally be adjusted either manually or automatically. For example, in the case of a shock absorber on an air-sprung truck, the pre-charge pressure can be adjusted by a connection from the air suspension (to give a signal indicative of load) to the shock absorber to thereby provide load dependent damping. The connection can be either direct or through a device to separate the air suspension and the shock absorber gases and/or to amplify the air suspension pressure to generate a different shock absorber operating pressure.

1. A motion damping device including a damper valve having a valve body including a first face on a first side of the valve body and a second face on the opposing second side of the valve body, the damper valve further including at least first valving to provide a restriction to fluid flow across the damper valve in a first direction from the second side of the of the damper valve to the first side, the first valving including
a first valving disc seat on the second face of the valve body, the first valving disc seat having an outer edge,
at least one first valving port extending through the valve body from the first side to the second side, the at least one first valving port exiting the valve body inside the outer edge of the first valving seat,
at least one first valving disc seated on the first valving disc seat,
a first valving disc clamping face located substantially inside the at least one first valving port, the height of the first valving disc clamping face being offset from the maximum height of the first valving disc seat in a direction towards the valve body such that clamping of the at least one first valving disc to the first valving disc clamping face deflects the at least one first valving disc to a static preloaded position, wherein
the first valving disc seat is concave such that in cross-section, the angle of the first valving seat is greater than or equal to the angle of the at least one first valving disc in the static preloaded position.

2. A motion damping device as claimed in claim 1, wherein the damper valve further includes second valving to provide a restriction to fluid flow across the damper valve in a second direction from the first side of the of the damper valve to the second side, the second valving including
a second valving disc seat on the first face of the valve body, the second valving disc seat having an outer edge,
at least one second valving port extending from outside the outer edge of the first valving seat on the second side of the valve body through to the first side, the at least one second valving port exiting the valve body at a location radially separated outwardly from the location of the at least one first valving port on the first face and inside the outer edge of the second valving disc seat,
at least one second valving disc seated on the second valving disc seat,
a second valving disc clamping face located substantially inside the at least one second valving port, the height of the second valving disc clamping face being offset from the maximum height of the second valving disc seat in a direction towards the valve body such that clamping of the at least one second valving disc to the second valving disc clamping face deflects the at least one second valving disc to a static preloaded position, wherein
the second valving disc seat is concave such that in cross-section, the angle of the second valving seat is greater than or equal to the angle of the at least one second valving disc in the static preloaded position.

3. A motion damping device as claimed in claim 2, further including a cylinder, a piston dividing the cylinder into a compression chamber and a rebound chamber, and a rod extending from the piston through at least the rebound chamber, wherein the piston includes the damper valve, the first face of the damper valve being a compression face, the first valving being compression valving, the second face being a rebound face and the second valving being rebound valving.

4. A motion damping device as claimed in claim 3, wherein the at least one rebound port is in fluid communication with a passage in the rod, the passage in the rod being in fluid communication with the rebound chamber through at least one peripheral rod port such that rebound flow out of the rebound chamber flows through the at least one peripheral rod port, through the passage in the rod and through the at least one rebound port.

5. A shock absorber assembly including a cylinder, a piston dividing the cylinder into a compression chamber and a rebound chamber, and a rod extending from the piston through at least the rebound chamber, the piston having a compression chamber piston face and an annular rebound chamber piston face, a rebound disc seat being provided on the compression chamber piston face and a compression disc seat being provided on the rebound chamber piston face,
compression ports arranged outside the rebound disc seat of the compression chamber piston face passing through the piston to inside an outer edge of the compression disc seat on the annular rebound chamber piston face,
at least one rebound port arranged inside the outer edge of the rebound disc seat of the compression chamber piston face, the at least one rebound port being in fluid communication with a passage in the rod, the passage in the rod being in fluid communication with the rebound chamber through at least one peripheral rod port such that rebound flow out of the rebound chamber flows through the at least one peripheral rod port, through the passage in the rod and through the at least one rebound port,
the shock absorber further including at least one compression disc clamped to the compression disc seat of the annular rebound chamber piston face and at least one rebound disc clamped to the rebound disc seat of the compression chamber piston face, such that compression flow between the compression and rebound chambers flows at least substantially through the compression ports and rebound flow between the compression and rebound chambers flows at least substantially through the at least one rebound port;
wherein the compression disc seat is raised a height above the rebound chamber piston face, the at least one compression disc being clamped down against a compression disc clamping face which is lower than the height of the compression disc seat giving a deflection of the at least one compression disc, the compression disc seat being angled to provide a sealing surface substantially aligned with the at least one compression disc, and
the rebound disc seat is raised a height above the compression chamber piston face, the at least one rebound disc being clamped down against a rebound disc clamping face which is lower than the height of the rebound disc seat giving a deflection of the at least one rebound disc, the rebound disc seat being angled to provide a sealing surface substantially aligned with the at least one rebound disc.

6. A shock absorber assembly including a cylinder, a piston dividing the cylinder into a compression chamber and a rebound chamber, and a rod extending from the piston through at least the rebound chamber, the piston having a compression chamber piston face and an annular rebound chamber piston face, a rebound disc seat being provided on the compression chamber piston face and a compression disc seat being provided on the rebound chamber piston face,
compression ports arranged outside the rebound disc seat of the compression chamber piston face passing through the piston to inside an outer edge of the compression disc seat on the annular rebound chamber piston face,
at least one rebound port arranged inside the outer edge of the rebound disc seat of the compression chamber piston face, the at least one rebound port being in fluid communication with a passage in the rod, the passage in the rod being in fluid communication with the rebound chamber through at least one peripheral rod port such that rebound flow out of the rebound chamber flows through the at least one peripheral rod port, through the passage in the rod and through the at least one rebound port,
the shock absorber further including at least one compression disc connected to the compression disc seat of the annular rebound chamber piston face and at least one rebound disc connected to the rebound disc seat of the compression chamber piston face, such that compression flow between the compression and rebound chambers flows at least substantially through the compression ports and rebound flow between the compression and rebound chambers flows at least substantially through the at least one rebound port;
wherein the compression disc seat projects beyond the rebound chamber piston face, the at least one compression disc being connected against a compression disc face beyond which the compression disc seat projects giving a deflection of the at least one compression disc, the compression disc seat being angled to provide a sealing surface substantially aligned with the at least one compression disc, and
the rebound disc seat projects beyond the compression chamber piston face, the at least one rebound disc being connected against a rebound disc face beyond which the rebound disc seat projects giving a deflection of the at least one rebound disc, the rebound disc seat being angled to provide a sealing surface substantially aligned with the at least one rebound disc.
